(19) United States
(12) Patent Application Publication
(10) Pub. No.: US 2026/0370622 A1
(43) Pub. Date: Nov. 19, 2026

(54) BAYESIAN FRAMEWORK FOR PERSONALIZED COMMUNICATIONS

(71) Applicant: Expedia, Inc., Seattle, WA (US)

(72) Inventors: Nestor Pereira, Austin, TX (US); Muhammad Hussain Anwaar, Austin, TX (US); Stephen McDonald, Austin, TX (US)

(73) Assignee: Expedia, Inc., Seattle, WA (US)

(21) Appl. No.: 19/675,110

(22) Filed: May 12, 2026

Related U.S. Application Data
(60) Provisional application No. 63/805,125, filed on May 13, 2025.

(51) Int. Cl. H04L 51/224

(52) U.S. Cl. CPC H04L 51/224

(57) ABSTRACT

At least one aspect relates to a notification system for determining timing of transmitting notifications to a user. The system may assign the user to a cluster based on one or more characteristics of the user and clusters of users. The system may generate a baseline probability distribution for the cluster across a plurality of time buckets. The system may transmit, to the user, a first plurality of notifications during a first set of two or more of the time buckets. The system may obtain behavior data indicating whether the user interacted with the first plurality of notifications. The system may adjust the baseline probability distribution based on the behavior data to generate a personalized probability distribution. The system may transmit a second plurality of notifications during a second set of two or more of the time buckets using the personalized probability distribution.

### CROSS-REFERENCE TO RELATED APPLICATIONS

This application claims the benefit of and priority to U.S. Provisional Application No. 63/805,125, filed May 13, 2025, which is incorporated herein by reference in its entirety and for all purposes.

### TECHNICAL FIELD

The present disclosure relates generally to communication systems. Specifically, the present disclosure relates to personalized transmission of notifications to user devices.

### BACKGROUND

Some communication systems may encounter difficulties associated with aligning transmission of messages to user devices with user preferences. For example, a user may have a preferred time-of-day or day-of-week for receiving messages, or there may be times where a user is unable to respond to messages. These difficulties are further complicated when the user has only a few interactions with an application or webpage, leading to a scarcity of individualized data for the respective user that indicates their preferences. In these situations, sent messages are at risk of being ignored unless user preferences are manually received from the users, which may negatively impact the overall user experience.

### SUMMARY

At least one aspect relates to a notification system for determining timing of transmitting notifications to a user. The system may include a non-transitory computer-readable medium having instructions stored thereon to be executed by one or more processors. The instructions may cause the one or more processors to assign the user to a cluster of a plurality of clusters of users based on one or more characteristics of the user and the clusters of users. The instructions may cause the one or more processors to generate a baseline probability distribution for the cluster across a plurality of time buckets, the baseline probability distribution including a distribution of probabilities of the users of the cluster interacting with a notification transmitted during the plurality of time buckets, the plurality of time buckets covering different time ranges. The instructions may cause the one or more processors to transmit, to the user, a first plurality of notifications during a first set of two or more of the plurality of time buckets, wherein an amount of notifications sent within each of the two or more time buckets is determined using the baseline probability distribution for the cluster. The instructions may cause the one or more processors to obtain behavior data indicating whether the user interacted with the first plurality of notifications. The instructions may cause the one or more processors to adjust the baseline probability distribution based on the behavior data to generate a personalized probability distribution for the user. The instructions may cause the one or more processors to transmit a second plurality of notifications during a second set of two or more of the time buckets using the personalized probability distribution for the user.

In some implementations, the instructions cause the one or more processors to obtain behavior data indicating whether the user interacted with the first plurality of notifications, adjust the baseline probability distribution based on the behavior data to generate a personalized probability distribution for the user, and transmit a second plurality of notifications during a second set of two or more of the time buckets using the personalized probability distribution for the user.

In some implementations, the instructions cause the one or more processors to adjust the personalized probability distribution by inputting the behavior data into a reinforcement learning model. In some implementations, the first set of time buckets (a) includes at least one of the same time buckets as the second set of time buckets or (b) includes none of the same time buckets as the second set of time buckets.

In some implementations, the baseline probability distribution is a Bayesian probability distribution, and where the instructions cause the one or more processors to generate the baseline probability distribution using a Bayesian model. In some implementations, the amount of notifications sent during the two or more time buckets of the first set of time buckets is based on a likelihood of interaction for the users of the cluster. In some implementations, an interaction with a notification includes at least one of (a) an application visit, (b) a webpage visit, (c) a purchase, or (d) an interaction with an embedded link of the notification.

In some implementations, adjusting the baseline distribution to generate the personalized distribution includes determining, based on the behavior data, a first set of probabilities of the user to interact with a notification sent during each time bucket of the first set of two or more of the plurality of time buckets, comparing the first set of probabilities to a second set of probabilities indicated by the baseline probability distribution, and adjusting the baseline probability distribution such that the personalized distribution indicates the first set of probabilities. In some implementations, the first set of probabilities and the second set of probabilities are different for at least one of the first set of two or more of the plurality of time buckets.

Another aspect relates to a method. The method may include assigning a user to a cluster of a plurality of clusters of users based on one or more characteristics of the user and the clusters of users. The method may include generating a baseline probability distribution for the cluster across a plurality of time buckets, the baseline probability distribution including a distribution of probabilities of users of the cluster interacting with a notification transmitted during the plurality of time buckets, the plurality of time buckets covering different time ranges. The method may include obtaining behavior data indicating whether the user interacted with a first plurality of notifications during a first set of two or more of the plurality of time buckets, wherein an amount of notifications sent within each time bucket of the first set of two or more of the plurality of time buckets is determined using the baseline probability distribution for the cluster. The method may include adjusting the baseline probability distribution based on the behavior data to generate a personalized probability distribution for the user.

In some implementations, the method may include obtaining behavior data indicating whether the user interacted with a second plurality of notifications transmitted during a second set of two or more of the plurality of time buckets using the personalized probability distribution, and adjusting the personalized probability distribution based on the behavior data.

In some implementations, the method may include adjusting the personalized probability distribution by inputting the behavior data into a reinforcement learning model.

In some implementations, the first set of two or more of the plurality of time buckets (a) includes at least one of a same time bucket as the second set of two or more of the plurality of time buckets or (b) includes none of the same time buckets as the second set of two or more of the plurality of time buckets.

In some implementations, the baseline probability distribution is a Bayesian probability distribution, and the method may include generating the baseline probability distribution using a Bayesian model.

In some implementations, the method may include determining, based on the behavior data, a first set of probabilities of the user to interact with a notification sent during each time bucket of the first set of two or more of the plurality of time buckets, comparing the first set of probabilities to a second set of probabilities indicated by the baseline probability distribution, and adjusting the baseline probability distribution such that the personalized probability distribution indicates the first set of probabilities.

Another aspect may relate to one or more non-transitory computer-readable media storing instructions thereon that, when executed by one or more processors, cause the one or more processors to assign a user to a cluster of a plurality of clusters of users based on one or more characteristics of the user and the clusters of users, generate a baseline probability distribution for the cluster across a plurality of time buckets, the baseline probability distribution including a distribution of probabilities of users of the cluster interacting with a notification transmitted during the plurality of time buckets, the plurality of time buckets covering different time ranges, obtain behavior data indicating whether the user interacted with a first plurality of notifications during a first set of two or more of the plurality of time buckets, wherein an amount of notifications sent within each time bucket of the first set of two or more of the plurality of time buckets is determined using the baseline probability distribution for the cluster, and adjust the baseline probability distribution based on the behavior data to generate a personalized probability distribution for the user.

In some implementations, the instructions further cause the one or more processors to obtain behavior data indicating whether the user interacted with a second plurality of notifications transmitted during a second set of two or more of the plurality of time buckets using the personalized probability distribution, and adjust the personalized probability distribution based on the behavior data.

In some implementations, the instructions further cause the one or more processors to adjust the personalized probability distribution by inputting the behavior data into a reinforcement learning model.

In some implementations, the first set of two or more of the plurality of time buckets (a) includes at least one of a same time bucket as the second set of two or more of the plurality of time buckets or (b) includes none of the same time buckets as the second set of two or more of the plurality of time buckets.

In some implementations, the baseline probability distribution is a Bayesian probability distribution, and the instructions may further cause the one or more processors to generate the baseline probability distribution using a Bayesian model.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a notification system for determining timing of transmitting notifications to user devices.

FIG. 2 is a flow diagram of a method for determining timing of transmitting notifications using the notification system of FIG. 1, according to some examples.

FIG. 3 is a graph showing a distribution of user devices across clusters, according to some examples.

FIG. 4A is a graph showing activity metrics for a cluster of user devices at a plurality of time buckets, according to some examples.

FIG. 4B is a graph showing a probability distribution based on the activity metrics of FIG. 4A, according to some examples.

FIG. 4C is a graph showing a sampling of the probability distribution of FIG. 4B, according to some examples.

FIG. 5A is a graph showing a probability distribution for a cluster of user devices at a plurality of time buckets, according to some examples.

FIG. 5B is a graph showing trend data of notifications sent at the time buckets of FIG. 5A, according to some examples.

FIG. 5C is a graph showing a personalized probability distribution based on the probability distribution of FIG. 5A, according to some examples.

FIG. 5D is a graph showing trend data of notifications sent at the time buckets of FIG. 5C, according to some examples.

The details of various implementations of the methods and systems are set forth in the accompanying drawings and the description below.

### DETAILED DESCRIPTION

Following below are more detailed descriptions of various concepts related to, and implementations of, methods, apparatuses, and systems of personalizing notification schedules for user devices. Before turning to the figures, which illustrate certain examples in detail, it should be understood that the present disclosure is not limited to the details or methodology set forth in the description or illustrated in the figures. The various concepts introduced above and discussed in greater detail below can be implemented in any of numerous ways. It should also be understood that the terminology used herein is for the purpose of description only and should not be regarded as limiting.

Referring generally to the figures, when sending notifications (e.g., push notifications, emails, text messages, etc.) to user devices (e.g., computers, smartphones, etc.), it may be difficult to determine a time to send a notification that maximizes a probability that a user will interact with (e.g., engage with, respond to) the notification while avoiding notification fatigue (e.g., caused by an excessively high volume of notifications). In some instances, there may be a scarcity of data associated with users, making it difficult to predict user behavior and/or preferences regarding receiving notifications. For example, if a user has a limited number of interactions with notifications, it may be difficult to determine the user's likelihood of engagement with notifications deployed at various times. Accordingly, identifying desirable times for sending notifications can help notifications be seen and interacted with at a time convenient for users.

In some instances, to resolve a scarcity in user data, systems may deploy a plurality of similar notifications at a plurality of different times. For example, some systems may transmit a notification at a first time, and subsequently transmit the notification at a second time to determine whether the user will interact with the notification at the first time and/or the second time. However, transmitting a single notification at multiple times may increase the computational resource consumption associated with transmitting notifications, since multiple transmissions may occur for a single notification. Additionally, or alternatively, transmitting notifications at multiple different times may increase transmission overhead of the system. For example, the system may need to store a large message queue and/or may experience latency due to the increased number of transmissions to various user devices.

Systems and methods described herein seek to address challenges related to scarcity of data for user devices for determining when to send notifications. In some implementations, user devices may be placed or assigned into clusters based on shared behavior characteristics. The behavior characteristics can be determined from the limited amount of collected data associated with each user device from past webpage or application visits. Clustering users based on shared behavior allows for decision-making based on collective data for a plurality of users, thereby increasing the total amount of data that can be used to make decisions. An activity metric may be calculated for each cluster, indicating a probability of users of the cluster to interact (e.g., engage) with a notification sent during each of a plurality of time buckets (e.g., time ranges). The activity metric may allow for generalization of each cluster (e.g., aggregating user data into a collective metric) into a representative value.

To address challenges related to notification fatigue, systems and methods described herein may determine a desired (e.g., optimal) time for sending notifications to user devices. In some implementations, a Bayesian hierarchical model may generate a Bayesian probability distribution for each of the clusters. The Bayesian probability distribution may include a plurality of probability distributions corresponding to a plurality of time buckets based a probability of users of the cluster engaging with a notification sent during that time bucket. The Bayesian probability distribution may be sampled to determine a time for sending notifications to users. For example, each distribution may be sampled, and the time bucket with the maximum sampled value may be chosen. By sampling the probability distribution for each time bucket, notifications can be sent to user devices at a plurality of different time buckets, with an overall number of notifications sent at each time bucket based on a likelihood of interaction. This approach may allow the system to avoid sending a single notification at a plurality of different times, which may reduce computational resource consumption and/or latency associated with sending notifications to user devices.

In some implementations, to further personalize deployment of notifications to users, the Bayesian probability distribution for each cluster may be updated as behavior (e.g., interaction) data is received for the cluster. For example, individual distributions of the Bayesian probability distribution may shift depending on an updated probability of interaction with a notification deployed at each time bucket. As another example, individual distributions may narrow/widen depending on the overall predictability (e.g., variance) of the users of the cluster in interacting with notifications deployed at each time bucket. In some implementations, as behavior data is collected for individual users, a personalized Bayesian probability distribution may be generated from the cluster Bayesian probability distribution. For example, based on a difference between the activity metric of the individual user and the activity metric of the cluster, a personalized distribution may better predict probability of interaction. In some implementations, personalized distributions can be updated as more data is collected using reinforcement learning techniques. For example, outcomes of deployed notifications (e.g., interaction, no interaction) can be input into a reinforcement learning model, and the personalized distributions can be updated accordingly.

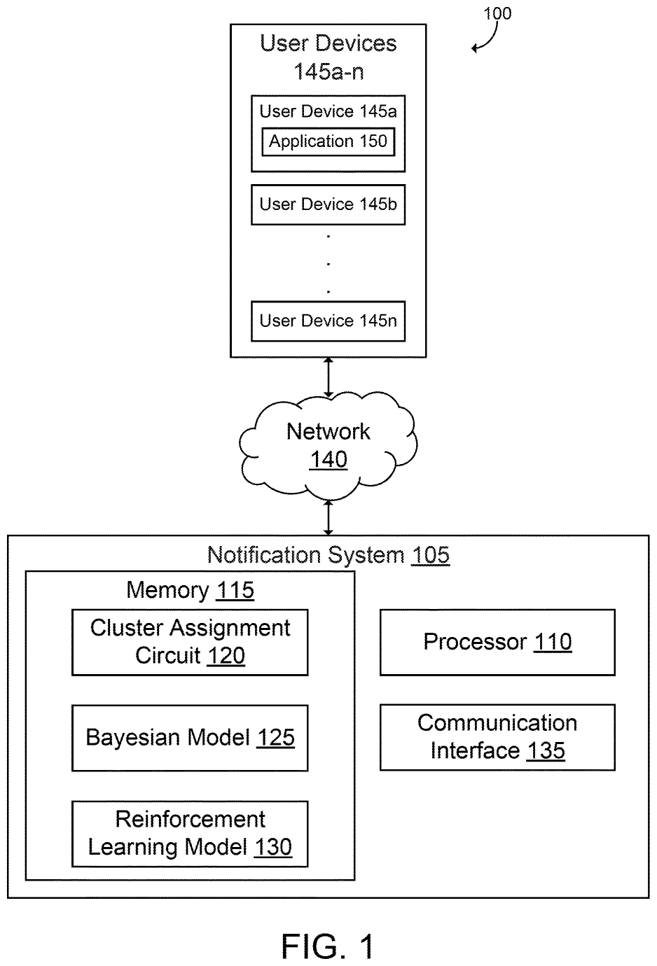

FIG. 1 depicts an example system 100 to provide personalized time of day (TOD) and/or day of week (DOW) notifications (e.g., communications) to user devices. For example, the system 100 can include at least one notification system 105, a network 140, and a set of user devices 145a-n.

The notification system 105 can include at least one processor 110. The processor 110 may be a single processor 110, or multiple processors 110 (e.g., multiple processors working alone or together to perform one or more steps or tasks together, such as in a distributed or cloud computing environment). The processor 110 can be implemented as a general-purpose processor, an application specific integrated circuit (ASIC), one or more field programmable gate arrays (FPGAs), an artificial intelligence (AI) processor (such as a neural processing unite (NPU) and tensor processing unite (TPU), a super scalar processor, a group of processing components, or other suitable electronic processing components.

Memory 115 is shown as including several components, including a cluster assignment circuit 120, a Bayesian model 125, and a reinforcement learning model 130. In some examples, these components may be implemented as instructions stored within the memory 115 or one or more other computer-readable storage media that are executable by the processor(s) 110 to perform various functions described herein. In some implementations, the components may additionally or alternatively be implemented in part or in whole using hardware. All such alternatives are contemplated within the scope of the present disclosure.

The memory 115 (e.g., memory, memory unit, storage device, etc.) may include one or more devices (e.g., RAM, ROM, flash memory, hard disk storage, etc.) for storing data and/or computer code for completing or facilitating the various processes, layers, and modules described in the present application. The memory 115 can be or include volatile memory or non-volatile memory. The memory 115 can include database components, object code components, script components, or any other type of information structure for supporting the various activities and information structures described in the present application. According to an example implementation, the memory 115 is communicably coupled to the processor 110 and includes computer code for executing (e.g., by the processor 110) one or more processes described herein.

The memory 115 may include the cluster assignment circuit 120. In various implementations, the cluster assignment circuit 120 can include any combination of hardware or software for processing instructions, such as instructions for providing functionalities of the notification system 105. The cluster assignment circuit 120 may store instructions for clustering (e.g., assigning, placing, sorting) the user devices 145a-n into clusters (e.g., groups). The clusters may be based on behavior (e.g., activity, interaction, etc.) data of the user devices 145a-n. The cluster assignment circuit 120 may store or otherwise receive one or more parameters (e.g., behavior data types) for clustering user devices 145a-n. By way of example, the cluster assignment circuit 120 may cluster user devices 145a-n based on a number of visits (e.g., to an application and/or webpage), an average visit duration, and/or an average time spent per period (e.g., day, time) for each user device 145a-n. In some implementations, the cluster assignment circuit 120 clusters user devices 145a-n based on a single parameter (e.g., behavior type). In some implementations, the cluster assignment circuit 120 clusters user devices 145a-n based on a weighted average of a plurality of behavior data types.

The cluster assignment circuit 120 may store and/or receive indication of a number or category of clusters for clustering user devices 145a-n. For example, the cluster assignment circuit 120 may cluster user devices 145a-n into a first number of clusters based on a historic TOD (e.g., morning, afternoon, evening, and night) for visiting an application and/or webpage. As another example, the cluster assignment circuit 120 may cluster user devices 145a-n into a second number of clusters based on a historic DOW for visiting an application and/or webpage.

The memory 115 may include a Bayesian model 125. In some implementations, the Bayesian model 125 is a Bayesian hierarchical model. The Bayesian model 125 may store or receive an indication of the clusters (e.g., cluster names, cluster identifiers, group identifiers, etc.) from the cluster assignment circuit 120. The Bayesian model 125 may include algorithms or other internal processes to generate a Bayesian probability distribution for each cluster. The Bayesian probability distribution may include a plurality of probability distributions corresponding to a plurality of time buckets (e.g., times, days, periods, etc.). The Bayesian model 125 may generate the probability distributions by calculating (e.g., determining, generating, etc.) an activity metric for each respective cluster at each of a plurality of TOD and/or DOW time buckets. For example, the activity metric may indicate or measure how active (e.g., likely to interact) an average user device 145 of the cluster is with an application or website during the time bucket. Based on the activity metric at each time bucket, the Bayesian model 125 may generate the probability distributions such that the values of the probability distributions correspond to the activity metrics. For example, a first time bucket with high activity metric may have a first probability distribution with a higher average value relative to a second probability distribution of a second time bucket with a lower (e.g., less active) activity metric.

The Bayesian model 125 may use the probability distributions for the cluster to select times for deploying notifications to the user devices of the cluster. In some implementations, the Bayesian model 125 may sample (e.g., randomly select values of) the probability distributions of each time bucket for the cluster to select a TOD/DOW for sending (e.g., deploying) notifications (e.g., communications) to the user devices 145a-n of the cluster. For example, the Bayesian model 125 may randomly select a value of the probability distribution at each time bucket, and deploy the notification at the time bucket corresponding to the maximum selected value. According to an example implementation, a cluster may have a first probability distribution corresponding to a first time bucket and a second probability distribution corresponding to a second time bucket. The Bayesian model 125 may randomly select a value from the first probability distribution and the second probability distribution, and send a notification during the time bucket with the larger selected value. Since the probability distributions are based on the activity metrics for the cluster at each time bucket, time buckets with higher activity metrics are more likely to have higher probability distribution values. For example, the first time bucket may have a first activity metric that is greater than a second activity metric for the second time bucket, and therefore the average value for the probability distribution of the first time bucket may be greater than the average value for the probability distribution of the second time bucket. As such, the Bayesian model 125 may select either the first time bucket or the second time bucket to deploy a respective notification, but the Bayesian model 125 may be more likely to select the first time bucket since its probability distribution has larger values on average.

In some implementations, the Bayesian model 125 may update the Bayesian probability distribution for each time bucket based on behavior data relating to notifications sent. For example, the Bayesian model 125 may set the Bayesian probability distribution as a prior distribution, and generate a posterior Bayesian probability distribution using the prior distribution and the behavior data. The posterior distribution may replace the prior distribution for future determinations on sending notifications.

In some implementations, the Bayesian model 125 may generate a personalized Bayesian probability distribution for an individual user device 145 based on behavior data of the individual user device 145. For example, the Bayesian model 125 may set the cluster's Bayesian probability distribution (e.g., original Bayesian probability distribution, updated Bayesian probability distribution) as a prior distribution, and generate a posterior (e.g., personalized) Bayesian probability distribution using the prior distribution and individual behavior data. The personalized Bayesian probability distribution may replace the prior distribution (e.g., cluster distribution) for future determinations on sending notifications. In some implementations, the Bayesian model 125 may use the cluster's Bayesian probability distribution for the individual user device 145 until a threshold number of notifications are deployed, and/or a threshold number of interactions are reached. For example, the Bayesian model 125 may wait until individual user device 145 has enough individual behavior data to generate the personalized Bayesian probability distribution. The threshold number of notifications and/or the threshold number of interactions may be based on a desired initial accuracy of the personalized Bayesian probability distribution and/or an amount of available computing resources. For example, higher thresholds may result in a more informed (e.g., fine-tuned) personalized Bayesian probability distribution at a higher computational cost, while lower thresholds may result in a less informed personalized Bayesian probability distribution that is more lightweight.

The reinforcement learning model 130 may adjust the personalized probability distributions of an individual user device 145 to further personalize deployment of notifications (e.g., communications). The reinforcement learning model 130 may utilize artificial intelligence and/or machine learning models to update the personalized probability distributions based on behavior data relating to user device 145 interactions with sent notifications. As referred to herein, an interaction with a notification may include at least one of an application visit, a webpage visit, or a purchase in response to receiving a notification, or an interaction with an embedded link of a notification. For example, responsive to each notification sent to the user device 145, the reinforcement learning model 130 may determine whether the notification had a positive response (e.g., a user interaction with the notification) or a negative response (e.g., the notification was ignored). The reinforcement learning model 130 may adjust the personalized probability distributions to maximize the number of positive responses to notifications sent to the user device 145. For example, in response to a positive response to a notification deployed during a first time bucket, the reinforcement learning model 130 may adjust the personalized probability distribution more favorably towards the first time bucket. As another example, in response to a negative response to a notification deployed during a second time bucket, the reinforcement learning model 130 may adjust the personalized probability distribution away from the second time bucket.

The communication interface 135 can include at least one of network communication devices, network interfaces, and/or other possible communication interfaces. The communication interface 135 can include wired or wireless communications interfaces (e.g., jacks, antennas, transmitters, receivers, transceivers, wire terminals, etc.) for conducting data communications with various systems, devices, and/or components described herein. The communication interface 135 can be direct (e.g., local wired or wireless communications) and/or via a communications network (e.g., the network 140). For example, the communication interface 135 can include an Ethernet card and port for sending and receiving data via an Ethernet-based communications link or network. The communication interface 135 can include a Wi-Fi transceiver for communicating via a wireless communications network (e.g., the network 140). The communication interface 135 can include a power line communications interface. The communication interface 135 can include an Ethernet interface, a USB interface, a serial communications interface, and/or a parallel communications interface.

In some examples, the network 140 may include at least one of a local area network (LAN), a wide area network (WAN), a telephone network (such as the Public Switched Telephone Network (PSTN)), a Controller Area Network (CAN), a wireless link, an intranet, the Internet, a cellular network, and/or combinations thereof. In some examples, the various systems, components, and/or other devices included in the system 100 may communicate with one another via the network 140. For example, the network 140 may receive behavior (e.g., activity, interaction) data (e.g., with an application or webpage, with a notification) from one of the user devices 145a-n and facilitate the transfer of the edits to the notification system 105 for processing. The network 140 may include a microservice that is designated for transmitting the behavior data. The network 140 may be configured to transmit (e.g., deploy) notifications (e.g., communications) to the user devices 145a-n. In some examples, the network 140 may include a pipeline to distribute information to the various user devices 145a-n. In some examples, the network 140 may include a database. The database may be a cloud-based database, such as a data lake. The database may be used for large-scale storage to store large volumes of behavior data for user devices 145a-n that has been accumulated over a predetermined period of time.

The user devices 145a-n may perform various actions and/or access various types of information. The information may be provided over the network 140. For example, the user devices 145a-n may be a mobile computing device, a desktop computer, a smartphone, a tablet, a smart watch, and/or any other device that can facilitate receiving and otherwise interacting with content from the network 140. The user devices 145a-n may display notifications from the notification system 105. For example, the notifications may be any of e-mail notifications, push notifications, application notifications, text messages, or other form of electronic communication. The user device may include an application 150 or be able to access a webpage with the application 150. The application 150 and/or webpage may store instructions such that when the user devices 145a-n interact with the webpage, interaction (e.g., activity, behavior, etc.) data can be transmitted to the notification system 105 (e.g., via the network 140). The application 150 and/or the webpage may associate interaction data with an identifier of the user devices 145a-n. For example, the application 150 and/or webpage may allow a user device 145 to create an account that generates an identifier of the user device. As another example, the application 150 and/or webpage may track an IP address of the user devices 145a-n, thereby allowing the notification system 105 to identify and/or retrieve interaction data for a specific user device 145a-n.

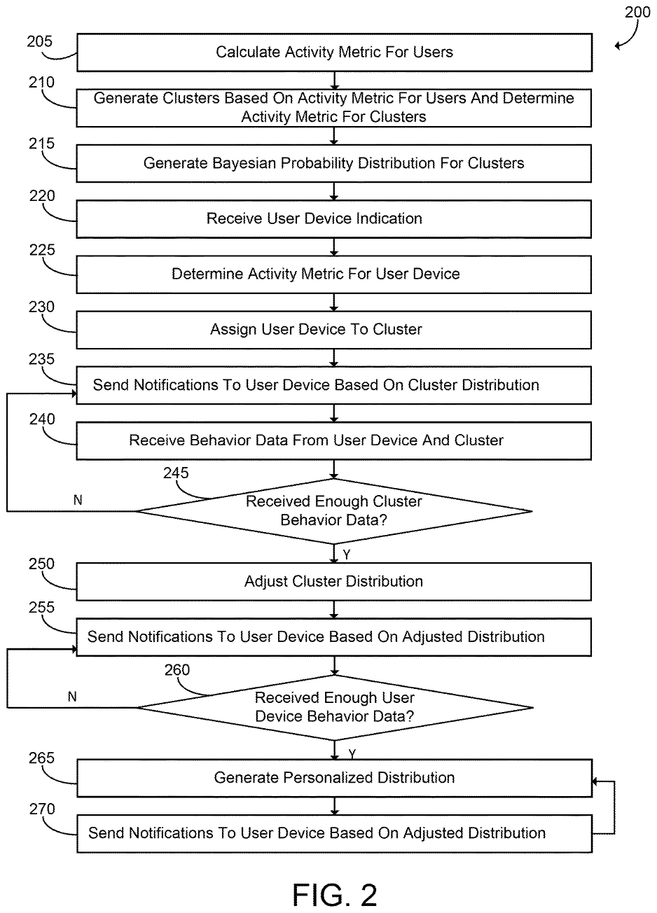

FIG. 2 depicts a flow diagram of an example method 200 for deploying personalized notifications to user devices. The method 200 may represent and/or illustrate one or more steps, actions, processes, and/or transmissions to receive, process, store, display and/or otherwise personalize notification deployment for user devices. The method 200 and/or one or more portions thereof may be executed by and/or carried out by the system 100 and/or one or more systems, devices, components, and/or elements thereof, in some implementations. The method 200 is meant to be an example and is not intended to be limiting. In various implementations, steps of the method 200 may be omitted, added, and/or ordered differently than the example implementation described herein. For example, certain steps of the method 200 may be performed in isolation, or a subset of the steps of the method 200 may be performed in sequence. Further, in some implementations, systems and/or components different from those shown in FIG. 1 may be used to implement/execute the features and steps shown in and described with respect to FIG. 2.

Referring now to FIGS. 1 and 2, at step 205 of method 200, the cluster assignment circuit 120 may calculate an activity metric for one or more user devices 145a-n. The cluster assignment circuit 120 may calculate or otherwise determine an activity metric for each user device 145a-n based on its behavior data at each time bucket. In some implementations, the activity metric is a weighted average of different types of behavior data. For example, the activity metric may be a weighted average of the number of visits, average visit duration, and average time spend per period at each time bucket. The weights of the behavior data may be based on an importance value associated with each type of behavior data. For example, if number of visits has a higher importance value than average time spend, the number of visits may have a higher weight in the activity metric. In some implementations, the activity metric may be based on a single behavior data type. For example, the cluster assignment circuit 120 may select a single type of behavior data (e.g., number of visits, average visit duration, time spend, etc.) to use to generate the clusters.

At step 210 of method 200, the cluster assignment circuit 120 may generate clusters based on the activity metrics for user devices 145a-n, and determine an activity metric for each cluster. In some implementations, the cluster assignment circuit 120 may receive, from a database of the network 140, behavior (e.g., visit, interaction) data regarding the user devices 145a-n activity on the application 150 or a webpage associated with the application 150. The behavior data may be based on a number of visits, average visit duration, and/or an average time spent per period on the application 150 and/or the webpage at a plurality of time buckets. By way of example, the time buckets may be hourly, daily, a period of time during the day (e.g., morning, afternoon, evening, night), or a different time-based grouping. In various implementations, there can be any number of time buckets signifying any time-based grouping.

The cluster assignment circuit 120 may assign, sort, or otherwise cluster user devices 145a-n based on one or more characteristics of the users and a plurality of clusters, such as assigning user devices 145a-n based on similar activity metrics and/or behavior data. In some cases, clustering user devices 145a-n based on similar activity metrics and/or behavior data may allow for the notification system 105 to make more informed decisions about sending notifications to user devices 145a-n when there is a scarcity of data for each individual user device 145a-n. For example, if a first user device 145a and a second user device 145b are in the same cluster, the notification system 105 can make decisions for both user devices based on the combined dataset (e.g., behavior data) of the user device 145a and user device 145b. The cluster assignment circuit 120 may cluster the user devices 145a-n using K-Means clustering or using a different clustering model. In some implementations, the number of clusters for sorting user devices 145a-n into may be based on the time buckets. For example, if the time buckets are associated with a DOW the number of clusters may be a first number of clusters, and if the time buckets are associated with a TOD the number of clusters may be a second number of clusters. In some implementations, the number of clusters may be based on the number of user devices 145a-n, such that the number of user devices 145a-n in each cluster are not too many or too few. The number of clusters may be changed (e.g., updated) by the notification system 105 as additional user devices 145a-n are added.

In some implementations, there may be insufficient behavior data for at least one of the user devices 145a-n to be assigned to a cluster based on its activity metric. One or more clusters may correspond to an inconclusive (e.g., unknown, uncalculated) activity metric. For example, if a first user device 145a does not have sufficient behavior data to be assigned to a cluster with similar user devices, the first user device 145a may be assigned to a cluster with other user devices that also do not have sufficient behavior data.

The cluster assignment circuit 120 may calculate or otherwise determine an activity metric for each cluster at each time bucket. In some implementations, the activity metric for a cluster may be based on an average activity metric of each user device 145a-n of the cluster at each time bucket. In some implementations, the activity metric for a cluster may be based on a median activity metric of the user devices 145a-n of the cluster at each time bucket. In some implementations, the activity metric for a cluster may be based on a weighted average of the behavior data of the user devices 145a-n of the cluster at each time bucket. The activity metric for each cluster may correspond to a likelihood of an average user device 145a-n of the cluster interacting with a notification deployed at each time bucket.

At step 215, the Bayesian model 125 may generate a baseline Bayesian probability distribution for each cluster (e.g., baseline probability distribution) across a plurality of time buckets (e.g., TOD or DOW time buckets). The Bayesian probability distribution for a cluster may be based on the activity metric of the cluster at each time bucket. For example, the Bayesian probability distribution for a cluster can include a plurality of negative binomial distributions based on the activity metric, mean activity, and a dispersion parameter that accounts for variability beyond the mean (e.g., average user of the cluster) at each time bucket. The baseline probability distributions may include a distributions of probabilities of respective users of the clusters interacting with notifications transmitted during the plurality of time buckets (e.g., time ranges).

According to an illustrative example, the negative binomial distribution for a cluster corresponding to each time bucket may be a linear combination of multiple components. The mean activity of the cluster at a time bucket may be a linear combination of (a) a random intercept for the time bucket that captures overall activity level (e.g., across clusters), and (b) activities metrics of the cluster at each bucket with a corresponding slope. The random intercept may be modeled by a normal distribution, or may be a different distribution. The baseline activity levels at each time bucket may be modeled by a gamma distribution, or may be a different distribution. The slopes for the activity level of each time bucket may be modeled by a normal distribution with a small variance reflecting some level of uncertainty, or may be a different distribution. The dispersion parameter may be modeled by an exponential function, or may be a different function.

At step 220, the notification system 105 may receive an indication of a user device 145 (e.g., a new or unknown user device) registering with the notification system 105 (e.g., by way of creating an account or establishing a connection with the notification system 105). In some implementations, the notification system 105 may receive the indication responsive to the user device 145 interacting with the application 150 and/or a webpage affiliated with the application 150. The network 140 may store or otherwise maintain record of an identifier of the user device 145 and any behavior data collected associated with the user device 145. The network 140 may transmit or otherwise provide the identifier and the behavior data of the user device 145 to the notification system 105 (e.g., via the communication interface 135).

At step 225, based on the initial behavior data of the user device 145, the cluster assignment circuit 120 may determine or calculate an activity metric for the user device at each of the plurality of time buckets. If enough behavior data is collected for the user device 145 that an activity metric can be determined, the cluster assignment circuit 120 may determine the activity metric based on a weighted average of the behavior data. Otherwise, the cluster assignment circuit 120 may determine that there is not enough data present to determine an accurate (e.g., trustworthy, reliable) activity metric for the user device 145.

At step 230, the cluster assignment circuit 120 may assign the user device 145 to a cluster of the plurality of clusters based on one or more characteristics (e.g., activity metric) of the user device 145 and the plurality of clusters. The user device 145 may be assigned to a cluster based on the determined activity metric for the user device 145. For example, responsive to the user device 145 having a first activity metric at a first time bucket and a second activity metric at a second time bucket, the cluster assignment circuit 120 may assign the user device 145 to the cluster that has a similar first activity metric at the first time bucket and a similar second activity metric at the second time bucket. In some implementations, there may be an importance factor (e.g., weight) assigned to each activity metric of the user device 145, such that the user is more likely to be placed in a cluster with user devices that have a similar activity metric at the most dominant (e.g., frequent) time bucket. Responsive to the user device 145 not having enough behavior data to determine an accurate activity metric, the user device 145 may be placed in a cluster with other user devices that also do not have an enough behavior data.

At step 235, in some implementations, the notification system 105 may send or otherwise provide notifications (e.g., a first plurality of notifications) to the user device 145 and to the other user devices of the cluster based on the Bayesian probability distribution of the cluster (e.g., baseline distribution) during a first set of time buckets (e.g., a first subset of the plurality of time buckets). The number of notifications sent during each time bucket of the first set of time buckets may be based on a likelihood of interaction for the users of the cluster. Each probability distribution of the Bayesian probability distribution may be randomly sampled to determine a TOD or DOW to deploy (e.g., send, provide) the notifications. For example, if the Bayesian probability distribution for the cluster has four negative binomial distributions corresponding to four different time buckets, the notification system 105 may randomly choose (e.g., select) a point to sample the negative binomial distributions. Based on the associated value of the negative binomial distributions, the notification system 105 may determine a TOD/DOW to deploy the notifications. For example, the TOD/DOW may be selected based on the maximum value associated with the values of the distributions at the randomly chosen point. Since the negative binomial distributions may be sampled, the notifications may be provided to the user device 145 at a plurality of different time buckets. For example, based on a first sampling result, a first notification may be transmitted during a first time bucket, and based on a second sampling result a second notification may be transmitted during a second time bucket. The amount of notifications sent within each time bucket may be determined using the baseline probability distribution of the cluster. For example, on average, a higher number of notifications may be sent during a time bucket that is associated with a higher activity metric than during a different time bucket that is associated with a lower activity metric.

In some implementations, for the cluster of user devices that do not have an accurate activity metric, the Bayesian probability distribution may include equal negative binomial distributions at each of the time buckets, such that when sampled each time bucket has an equal probability of being selected as a TOD/DOW for deploying notifications. This may allow for an effectively random deployment of notifications and allow the notification system 105 to collect behavior data for the cluster at the plurality of time buckets, so that the activity metric for each user device of the cluster can be updated as more data is collected.

By sampling the Bayesian probability distribution of the cluster to determine TOD/DOW for deploying notifications, the notification system 105 may deploy notifications at a plurality of time buckets, while still predominantly providing notifications at time bucket that the cluster is most likely to interact with. In some implementations, the negative binomial distributions of the Bayesian probability distribution may have an average value based on the activity metric of the cluster associated with the time bucket of the negative binomial distribution. For example, if a first negative binomial distribution is associated with a higher activity metric than a second negative binomial distribution, the average value of the first negative binomial distribution may be larger than the average value of the second negative binomial distribution. When sampled, both the first and the second negative binomial distributions could have a higher value (e.g., and therefore be selected for deploying notifications), but on average the first binomial distribution will be selected more often than the second negative binomial distribution. This may allow for behavior data to be collected at a plurality of time buckets, while still maximizing probability of interaction with deployed notifications.

In some implementations, the width of each probability distribution of the Bayesian probability distribution may correspond to an uncertainty (e.g., variance) of the cluster in interacting with a notification deployed at that time bucket. For example, if some of the users of the cluster are likely to interact with a notification at a time bucket and some users are unlikely to interact with the notification at the time bucket, the distribution may be wider to account for variation in the likelihood of interaction. As another example, if most of the users of the cluster are very likely to interact with the notification, the probability distribution may be narrow to account for low variation.

At step 240, the notification system 105 may obtain behavior data for the user device 145 and other user devices 145a-n of the cluster as notifications are deployed during the first set of the plurality of time buckets. The behavior data may be based on interaction with deployed notifications and/or activity that occurs responsive to interaction with deployed notifications. The behavior data may indicate whether the user device 145 and/or other user devices 145a-n interacted with the plurality of notifications. For example, the behavior data may indicate a percentage of notifications interacted with at each time bucket. As another example, the behavior data can be a length of visit (e.g., to the application 150 or associated webpage) responsive to interacting with notifications at different time buckets. As yet another example, the behavior data can be a completion rate (e.g., purchase rate, add-to-cart rate) associated with deployment of notifications.

At step 245, the notification system 105 may determine whether enough behavior data (e.g., posterior data) has been received from the cluster to adjust (e.g., change, skew, update) the Bayesian probability distribution for the cluster. In some implementations, the behavior data may indicate that the current Bayesian probability distribution for the cluster does not maximize chances of interaction with deployed notifications. For example, if the cluster interacts with notifications deployed at a time bucket at an above average rate, it may be beneficial to update the Bayesian probability distribution for the cluster such that more notifications can be deployed at that time bucket. If there is not enough behavior data collected from the cluster to adjust the distribution and/or the behavior data indicates that the Bayesian probability distribution is working (e.g., operating) as intended, notifications may continue to be deployed to the user device 145 and the other devices of the cluster based on the original (e.g., baseline) Bayesian probability distribution (as in step 235).

In some implementations, the notification system 105 may automatically determine to adjust the Bayesian probability distribution. For example, the notification system 105 may be set (e.g., programmed) to automatically initiate adjustment of the Bayesian probability distribution after a predetermined time interval, regardless of the amount of data collected. The predetermined time interval may be a month, three months, one year, and/or any other period of time.

At step 250, responsive to the notification system 105 receiving enough behavior (e.g., posterior) data to adjust the Bayesian probability distribution for the cluster, the notification system 105 (e.g., via the Bayesian model 125) may update (e.g., adjust, fine-tune) the baseline Bayesian probability distribution for the cluster. In some implementations, updating the Bayesian probability distribution (e.g., calculating a posterior distribution for the cluster) may be computationally inefficient (e.g., difficult) due to the complexity of the Bayesian model 125. Accordingly, other models (e.g., PyMC library) may be used to approximate an updated Bayesian probability distribution. For example, the code may be PyMC code using a sampling method such as Markov Chain Monte Carlo (MCMC) to generate samples from the updated Bayesian probability distribution (e.g., posterior distribution). The samples may provide an empirical estimate of the updated Bayesian probability distribution, which can be used to determine TOD/DOW times for deployment of notifications.

In some implementations, samples from the updated Bayesian probability distribution (e.g., posterior distribution) can be used to guide future decisions made by the Bayesian model 125. For example, the updated Bayesian probability distribution may be used to sample for engagement (e.g., interaction likelihood) with deployed notifications. As another example, the updated Bayesian probability distribution may be used to refine decisions made by the Bayesian model 125 dynamically, based on historical user device 145a-n behavior and real-time feedback (e.g., from new behavior data). As yet another example, the updated Bayesian probability distribution may be used to select TOD/DOW time buckets that yield the largest sample as the time to send (e.g., deploy) notifications.

At step 255, in some implementations, the notification system 105 may send or otherwise provide notifications to the user device 145 and the cluster of the user device 145 based on the updated Bayesian probability distribution (e.g., posterior distribution) of the cluster at each time bucket. The updated Bayesian probability distribution may be randomly sampled to determine a TOD or DOW to deploy (e.g., send, provide) the notifications. For example, if the updated Bayesian probability distribution for the cluster has four negative binomial distributions corresponding to four different time buckets, the notification system 105 may randomly choose (e.g., select) a point to sample the negative binomial distributions. Based on the associated value of the negative binomial distributions, the notification system 105 may determine a TOD/DOW to deploy the notifications. For example, the TOD/DOW may be selected based on the maximum value associated with the values of the distributions at the randomly chosen point.

At step 260, the notification system 105 may determine whether enough behavior data has been collected for the user device 145 to generate (e.g., create) a personalized Bayesian probability distribution for the user device 145. In some implementations, the behavior data for the user device 145 may indicate that the cluster's Bayesian probability distribution (e.g., baseline distribution, updated distribution, posterior distribution) does not maximize chances of interaction with deployed notifications. For example, if the user device 145 interacts with notifications at a time bucket more than the average user device of the cluster, it may be beneficial to adjust (e.g., skew, move, update) the Bayesian probability distribution of the user device 145 to deploy more notifications at that time bucket. If there is not enough behavior data collected from the user device 145 to create a personalized distribution, notifications may continue to be deployed to the user device 145 based on the cluster distribution (as discussed in step 255).

At step 265, the notification system 105 may adjust the baseline Bayesian probability distribution for the cluster based on the behavior data for the user device 145 to generate a personalized Bayesian probability distribution for the user device 145. For example, the notification system 105 may adjust the baseline Bayesian probability distribution for the cluster using behavior data from the user device 145, and not using behavior data from other user devices. The notification system 105 may use the reinforcement learning model 130 or a different model to (e.g., continuously) update the personalized Bayesian probability distribution based on behavior data in real-time. For example, a positive outcome (e.g., interaction, visit, purchase etc.) resulting from a decision made using the personalized Bayesian probability distribution may increase the likelihood that similar decisions are made (e.g., by adjusting the personalized Bayesian probability distribution). As another example, a negative outcome (e.g., ignored notification) may cause different decisions to be made (e.g., by adjusting the personalized Bayesian probability distribution). The personalized Bayesian probability distribution may remain separate from the clusters'Bayesian probability distributions. For example, the personalized Bayesian probability distribution may be generated and adjusted (e.g., by the reinforcement learning model 130) without impacting the probability distribution of the cluster(s).

According to an illustrative implementation, the personalized Bayesian probability distribution may use a Beta distribution or a different distribution to adjust the updated Bayesian probability distribution for the user device 145. The Beta distribution may be used to adjust the negative binomial distributions. The Beta distribution may have a first parameter (sometimes referred to as “alpha”) corresponding to a count of positive (e.g., desired or optimal) outcomes for notifications sent to the user device 145, and a second parameter (sometimes referred to as “beta”) corresponding to a count of suboptimal, undesired, or negative outcomes for notifications to the user device 145. The parameters alpha and beta may be updated as behavior data is collected.

The mean of the binomial distributions may be updated based on changes to alpha and beta. For example, an observed ratio for outcomes may be modeled as alpha divided by the sum of alpha and beta (e.g., observed ratio =alpha/(alpha +beta)). A multiplier may be modeled as the observed ratio divided by an expected ratio (e.g., expected ratio of alpha to beta for the cluster). The mean of each binomial distribution may be updated based on the multiplier. For example, an updated mean may be modeled by μ′=μ*[1+η*(multiplier−1)], where μ′ is the updated mean, μ is the current mean, and η is a learning rate to control the adjustment (e.g., not too heavily influenced by short-term variability).

According to an illustrative example, to generate the personalized probability distribution, the notification system 105 may determine a first set of probabilities of the user device 145 to interact with a notification sent during each time bucket of the first set of time buckets. The notification system 105 may compare the first set of probabilities to a second set of probabilities indicated by the baseline Bayesian probability distribution for the cluster. For example, the second set of probabilities may indicate a probability for an average user of the cluster to interact with notifications sent during each time bucket. In some instances, the first set of probabilities and the second set of probabilities may be different for at least one time bucket. The notification system 105 may determine differences (e.g., variance) between the first set of probabilities and the second set of probabilities. For example, the notification system 105 may determine that the user device 145 is more likely to interact with a notification deployed during a first time bucket than an average user of the cluster. The notification system 105 may adjust the baseline probability distribution such that the personalized probability distribution indicates the first set of probabilities. According to an example, in response to determining that the user device 145 is more likely to interact with a notification during a first time bucket than the average user of the cluster, the personalized probability distribution may be shifted more towards the first time bucket than the baseline probability distribution, such that notifications are more likely to be deployed during the first time bucket.

At step 270, the notification system 105 may send or otherwise provide notifications (e.g., a second plurality of notifications) to the user device 145 based on the personalized Bayesian probability distribution during a second set of time buckets (e.g., a second subset of two or more of the plurality of time buckets). The personalized Bayesian probability distribution may be randomly sampled to determine a TOD or DOW to deploy (e.g., send, provide) the notifications to the user device 145. For example, if the personalized Bayesian probability distribution has four negative binomial distributions corresponding to four different time buckets, the notification system 105 may randomly choose (e.g., select) a point to sample the negative binomial distributions. Based on the sampled values of the negative binomial distributions, the notification system 105 may determine a TOD/DOW to deploy the notifications. For example, the TOD/DOW may be selected based on a maximum of the sampled values of the distributions.

As the notification system 105 transmits the second plurality of notifications, the notification system 105 may obtain behavior data indicating whether the user device 145 interacted with the second plurality of notifications. Based on behavior data that is collected responsive to sending the second plurality of notifications to the user device 145, the reinforcement learning model 130 may continuously adjust the personalized Bayesian probability distribution based on the behavior data. For example, the reinforcement learning model 130 may set the personalized Bayesian probability distribution as the prior distribution and generate a posterior distribution based on new behavior data collected by the notification system 105. As another example, the notification system 105 may provide the behavior data to the reinforcement learning model 130 as an input, and the reinforcement learning model 130 may update ethe personalized Bayesian probability distribution.

As described above (e.g., with reference to step 235 and step 270), the notification system 105 may transmit the first plurality of notifications to the user device 145 during a first set of time buckets and the second plurality of notifications to the user device 145 during a second set of time buckets. The first plurality of notifications may be transmitted to the user device 145 based on the Bayesian probability distribution for the cluster, and the second plurality of notifications may be transmitted to the user device 145 based on the personalized Bayesian probability distribution. As described herein, the first set of time buckets may include two or more of the plurality of time buckets that are selected as a result of sampling the Bayesian probability distribution for the cluster, and the second set of time buckets may include two or more of the plurality of time buckets that are selected as a result of sampling the personalized Bayesian probability distribution. In some instances, the first set of time buckets and the second set of time buckets may include at least one of the same time buckets. In some instances, the first set of time buckets and the second set of time buckets may include none of the same time buckets.

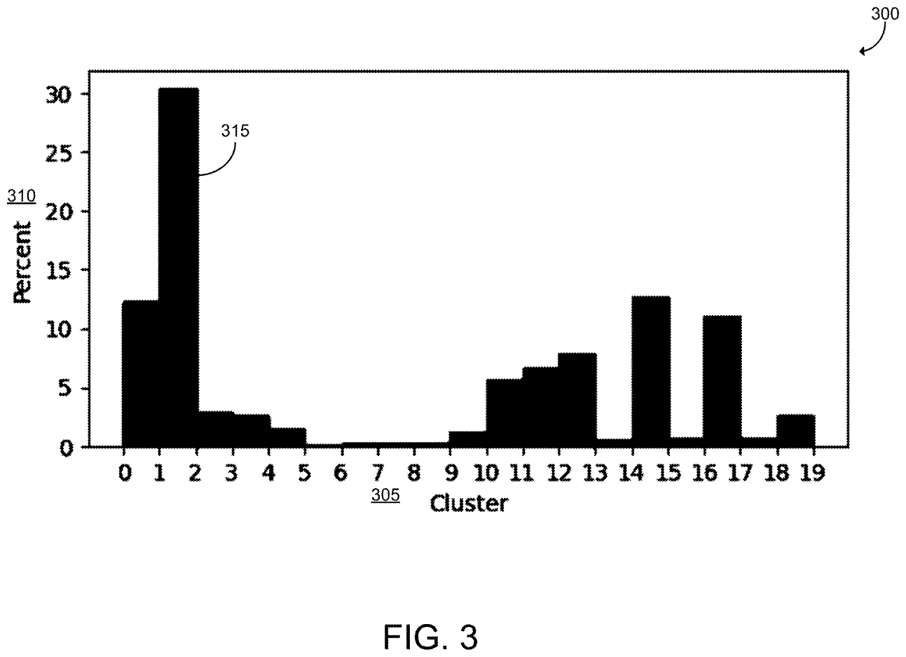

FIG. 3 depicts an example bar graph 300 of a distribution of user devices 145a-n across different clusters. Graph 300 is shown to include a horizontal axis 305. The horizontal axis 305 corresponds to the number of clusters of user devices 145a-n. In various implementations, there can be any number of clusters, and the number of clusters may be based on whether notification deployment is being determined on a TOD basis or a DOW basis. For example, for TOD there may be 20 clusters, and for DOW there may be 50 clusters. The number of clusters may be based on a total number of user devices 145a-n. For example, a larger number of user devices 145a-n may result in more clusters, to avoid overcrowding (e.g., overgeneralizing the user devices) of clusters. Graph 300 is shown to include a vertical axis 310. The vertical axis 310 corresponds to the percentage of user devices 145a-n in each cluster. Since clusters are based on similar behaviors (e.g., behavior data), there may be an unequal number of user devices 145a-n in each cluster. For example, the largest cluster, shown as cluster 315, is shown to include approximately 30% of the user devices 145 a-n. Cluster 315 may correspond to user devices with insufficient data for decision making (e.g., newer devices or newer accounts).

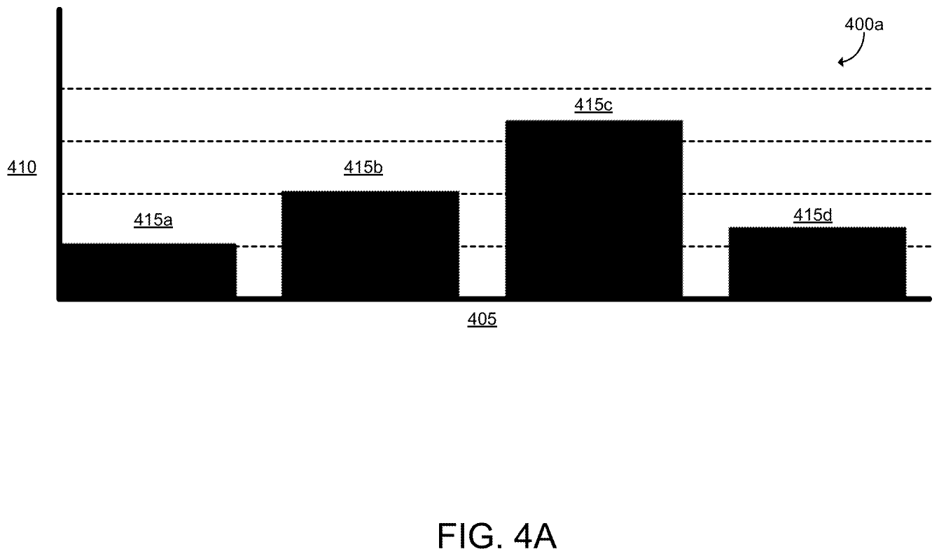

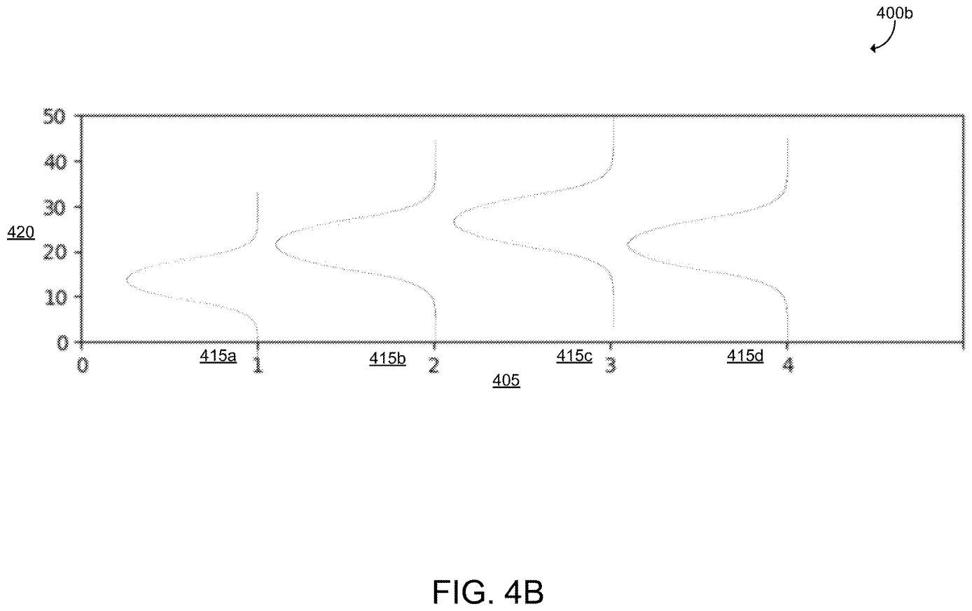

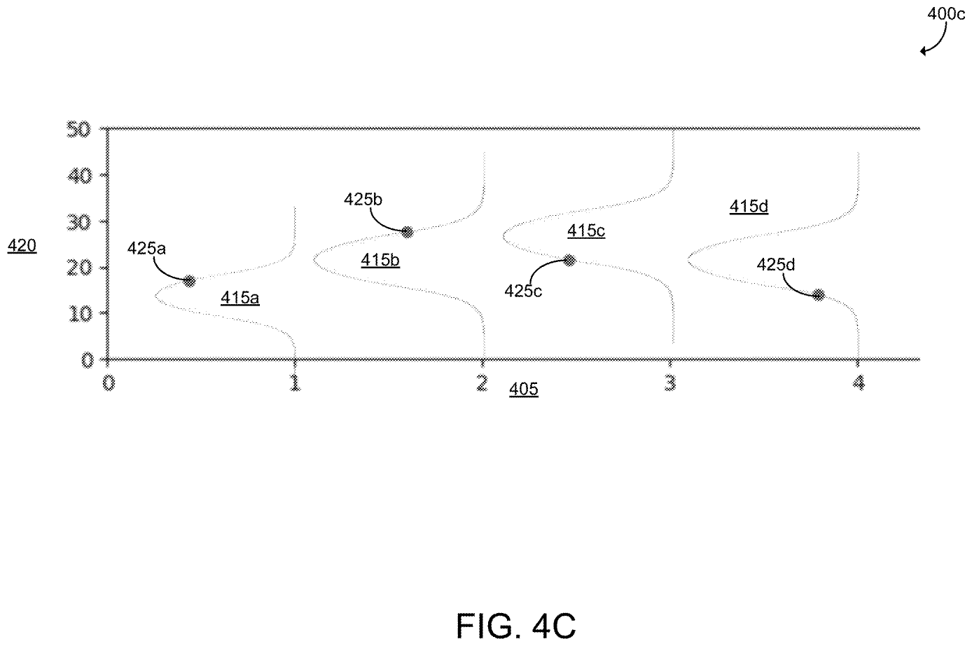

FIG. 4A depicts an example graph 400a of activity metrics of a cluster at a plurality of time buckets. Graph 400a is shown to include a horizontal axis 405. The horizontal axis 405 corresponds to a plurality of time buckets where notifications could be sent. For example, a first time bucket 415a can correspond to a morning time bucket, a second time bucket 415b can correspond to an afternoon time bucket, a third time bucket 415c can correspond to an evening time bucket, and a fourth time bucket 415d can correspond to a night time bucket. The graph 400a is shown to include a vertical axis 410. The vertical axis 410 corresponds to the activity metric of an average user device 145 (e.g., average user) of the cluster interacting with a notification deployed during each respective time bucket.

Based on the activity metrics at the plurality of time buckets, a Bayesian probability distribution can be generated for the cluster based on the activity metrics. The Bayesian probability distribution may include a negative binomial distribution corresponding to the activity metric at each time bucket. For example, for a time bucket with a relatively high activity metric (e.g., third time bucket 415c), the average value of the distribution for the time bucket will be greater than a time bucket with a relatively low activity metric (e.g., first time bucket 415a).

FIG. 4B depicts an example graph 400b of a Bayesian probability distribution for the cluster. The graph 400b is shown to include the horizontal axis 405 and a vertical axis 420. The vertical axis 420 corresponds to values of the probability distributions (e.g., negative binomial distributions) at each time bucket. To avoid sending notifications at fixed times, defining a probability distribution at each time bucket may allow for sending notifications at a plurality of times. For example, if each probability distribution is sampled at a random point, each time bucket (e.g., first bucket 415a, second bucket 415b, third bucket 415c, and fourth bucket 415 d) has a probability of having the maximum sampled value (e.g., being chosen for sending a notification). The probability distributions may be distributed such that time buckets with higher relative activity metrics are selected more often than time buckets with lower relative activity metrics. For example, the distribution of the third time bucket 415c has a larger average value than the first time bucket 415a. Accordingly, on average, the third time bucket 415c will have a larger sampled value than the first time bucket 415a.

Referring to FIGS. 1 and 4B, the probability distributions may be generated by the Bayesian model 125. In some implementations, the Bayesian model 125 can update or otherwise adjust the probability distributions for the cluster. For example, the Bayesian model 125 can generate a negative binomial distribution based on a mean activity in each time bucket and a dispersion parameter. The dispersion parameter can be modeled as an exponential function to account for variability beyond the mean.

The mean activity in each bucket may be modeled as a linear combination. The linear combination may include a random intercept specific to that bucket. The random intercept can be modeled as a truncated normal distribution based on the overall baseline activity across all clusters, and the variability in the overall baseline activity between clusters. The overall baseline activity can be modeled as a gamma distribution. The linear combination may include a representation of activity in the other buckets with a corresponding slope. The slopes may be represented as a normal distribution with a mean of 0 and a small variance that reflects uncertainty about the effects of the other time buckets.

The Bayesian model 125 may update the probability distributions for the cluster as behavior data is collected and/or the activity metrics of the cluster at the time buckets change. The probability distributions and/or components thereof can be set as prior distributions, and the Bayesian model 125 can refine (e.g., adjust) the prior distributions into posterior distribution estimates using the prior distributions and behavior data. For example, the Bayesian model 125 may use sampling methods (e.g., MCMC) to provide an empirical estimate of the posterior distribution. This may allow for continuous (e.g., real-time) updating of the negative binomial distributions used for sampling.

FIG. 4C depicts an example graph 400c showing a sampling of the cluster probability distributions. The graph 400c is shown to include the horizontal axis 405 (e.g., the time buckets 415a, 415b, 415c, and 415d) and the vertical axis 420 (e.g., values of the negative binomial distribution). In some implementations, determining a time to deploy (e.g., send notifications) is based on sampling the distribution of each time bucket at a random point, and selecting the maximum value of the samples along the vertical axis 420. The first time bucket 415a is shown to be sampled at a first point 425a. The second time bucket 415b is shown to be sampled at a second point 425b. The third time bucket 415c is shown to be sampled at a third point 425c. The fourth time bucket is shown to be sampled at a fourth point 425d. Since the value of the sampled points along the vertical axis 420 is largest at the second point 425b, the notification system 105 may send a notification during the second time bucket. Although the average value of the distribution for the third time bucket 415c is larger than the average value of the distribution of the second time bucket 415b, sampling the distributions may allow for notifications to be deployed at a plurality of time buckets. For example, in other samplings, a different time bucket may have the highest sampled value and be selected.

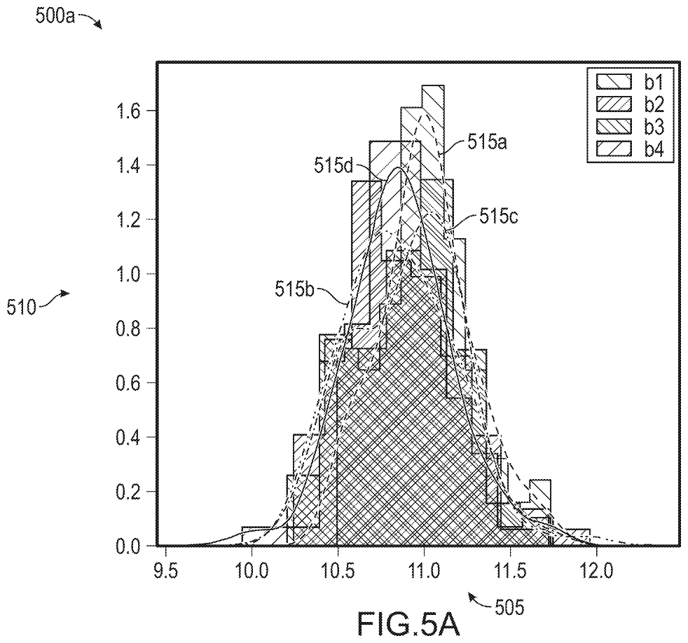

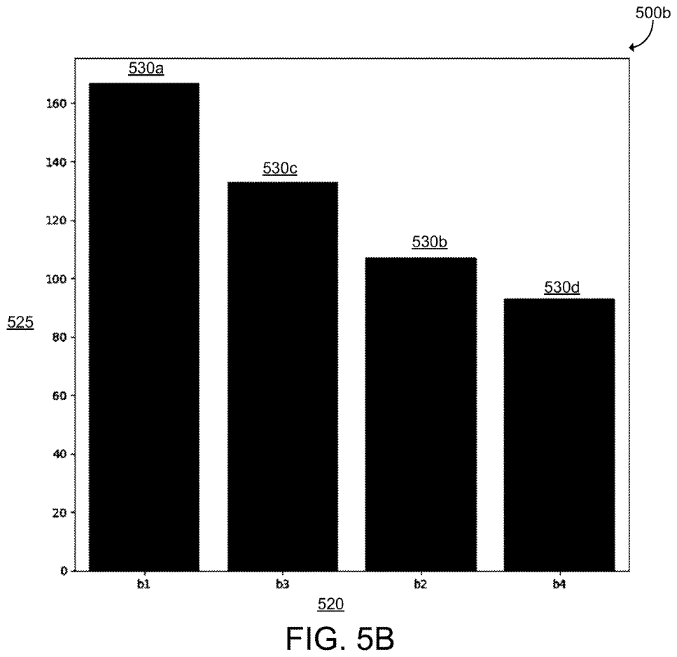

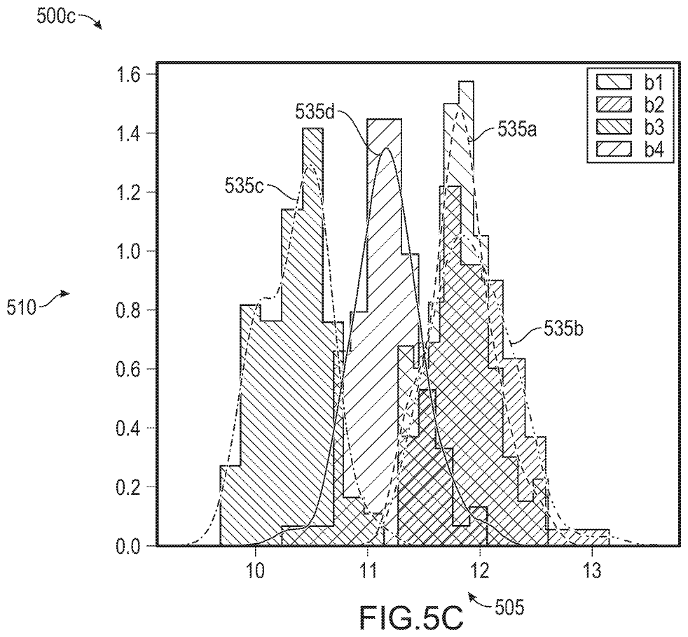

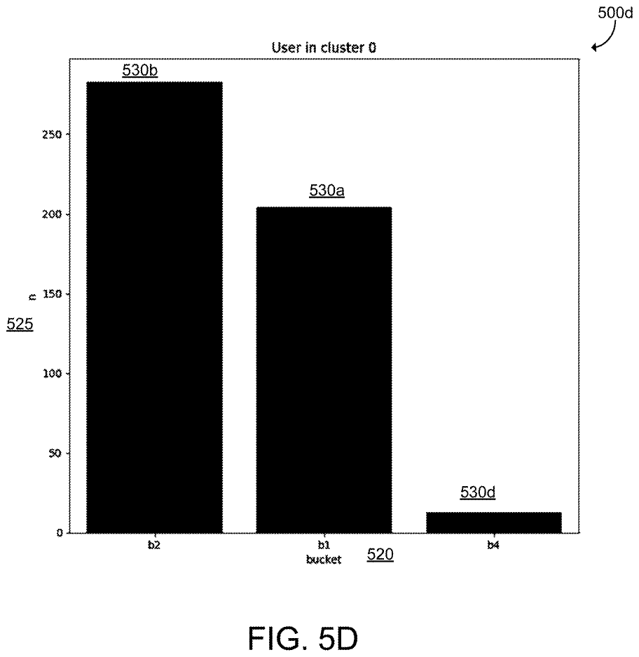

FIG. 5A depicts an example graph 500a showing a Bayesian probability distribution for a cluster. Graph 500a is shown to include a horizontal axis 505 and a vertical axis 510. The horizontal axis 505 corresponds to the activity metric of user devices 145a-n within the cluster. The vertical axis 510 corresponds to a density of user devices 145a-n in the cluster. The density of user devices 145a-n may be a percentage of user devices 145a-n, a number of user devices 145a-n, or any other value associated with a portion of user devices 145a-n of the cluster.

The graph 500a depicts a first distribution 515a (e.g., first probability distribution) corresponding to the activity metric of user devices 145a-n during a first time bucket, a second distribution 515b corresponding to the activity metric of user devices 145a-n during a second time bucket, a third distribution 515c corresponding to the activity metric of user devices 145a-n during a third time bucket, and a fourth distribution 515d corresponding to the activity metric of user devices 145a-n during a fourth time bucket. In some implementations, the distributions 515a-515d are negative binomial distributions based on the density of user devices 145a-n of the cluster at each activity metric. The distributions 515a-515d may be sampled to determine a time bucket for deploying a notification. For example, a random point on each distribution 515a-515d may be sampled, and the distribution with the random point corresponding to the largest activity metric can be chosen for sending a notification.

FIG. 5B depicts an example graph 500b showing a sampling trends for the cluster of FIG. 5A. The graph 500b is shown to include a horizontal axis 520 and a vertical axis 525. The horizontal axis 520 corresponds to the time buckets. For example, the horizontal axis 520 may include a first time bucket 530a, a second time bucket 530b, a third time bucket 530c, and a fourth time bucket 530d. The vertical axis 525 corresponds to the number of notifications deployed for each time bucket. For example, the number of notifications may be based on a plurality of samplings of a Bayesian probability distribution for the cluster.

Referring to FIGS. 5A and 5B, the graph 500b may be based on a plurality of samplings of the distributions 515a-515d graph 500a. The first distribution 515a may correspond to the first time bucket 530a, the second distribution 515b may correspond to the second time bucket 530b, the third distribution 515c may correspond to the third time bucket 530c, and the fourth distribution 515d may correspond to the fourth time bucket 530d. In some implementations, the distributions 515a-d may be iteratively sampled for each individual notification sent to the cluster. For example, to determine a time to send the notification, a random point of each distribution 515a-d may be sampled, and the distribution with the random point corresponding to the largest activity metric can be chosen for sending a notification.

The graph 500b shows the notification deployment trend of graph 500a. Graph 500b shows the most notifications being deployed in the first time bucket 530a, followed by the third time bucket 530c, followed by the second time bucket 530b, followed by the fourth time bucket 530d. The deployment trend of graph 500b is shown to align with the average values of the distributions 515a-d. For example, the average value of the first distribution 515a is greatest, and the most notifications are deployed during the first time bucket 530a. As another example, the average value of the fourth distribution 515d is the smallest, and the least notifications are deployed during the fourth time bucket 530d.

FIG. 5C depicts an example graph 500c of a personalized Bayesian probability distribution for a user device 145 of the cluster of FIG. 5A. The graph is shown to include the horizontal axis 505 and the vertical axis 510. The graph is shown to include a first personalized distribution 535a (e.g., first personalized probability distribution), a second personalized distribution 535b, a third personalized distribution 535c, and a fourth personalized distribution 535d.

Referring to FIGS. 5A-5C, the personalized Bayesian probability distribution of graph 500c may be based on the Bayesian probability distribution for the cluster of graph 500a. As behavior data is collected for the user device 145 associated with interaction with notifications, the activity metric (e.g., behavior) of the user device 145 may not align with the activity metric of the cluster at each time bucket. In some implementations, reinforcement learning models may be used to generate the personalized Bayesian probability distribution from the cluster Bayesian probability distribution. Each notification deployed to the user device 145 may be associated with a positive outcome or a negative outcome. For example, a positive outcome may include an interaction with the notification (e.g., an embedded link of the notification), an application 150 or webpage visit, a purchase, or a different engagement metric. As another example, a negative outcome may include ignoring the notification, or a different metric indicating that the notification was not sent at an optimal time for the user device 145.

Responsive to positive outcomes at a time bucket, the personalized Bayesian distribution may be adjusted to reflect an improved activity metric. In some implementations, a positive outcome may cause a rightward shift of a probability distribution. For example, the average value of the second personalized distribution 535b is greater than the average value of the second distribution 515b. This may indicate that the user device 145 is more likely to interact with notifications sent during the second time bucket 530b than other devices in the cluster. In some implementations, a negative outcome may cause a leftward shift of a probability distribution. For example, the average value of the third personalized distribution 535c is less than the average value of the third distribution 515c.

In some implementations, the width of the personalized distributions 535a-c may be based on a variability of activity responsive to notifications deployed to the user device 145 relative to other devices of the cluster. A wider personalized distribution relative to the cluster distribution may indicate that there is greater variation (e.g., less predictability) in interactions of the user device 145 responsive to notifications deployed at that time bucket. A narrower personalized distribution may indicate that there is less variation (e.g., more predictability) in interactions of the user device 145 responsive to notifications deployed at that time bucket relative to the cluster.

The personalized Bayesian probability distribution can be sampled to determine TOD/DOW to send notifications to the user device 145. In some implementations, once a personalized distribution is generated for the user device 145, notifications are no longer sent to the user device 145 based on sampling the cluster Bayesian probability distribution of the cluster, and only sent based on the personalized distribution.

FIG. 5D depicts an example graph 500d showing a sampling trends for the user device 145 of FIG. 5C (e.g., based on the personalized Bayesian probability distribution and/or reinforcement learning). The graph 500d is shown to include the horizontal axis 520 and the vertical axis 525. The horizontal axis 520 is shown to include the second time bucket 530b, the first time bucket 530a, and the fourth time bucket 530d.

Referring to FIGS. 5C and 5D, the graph 500d may be based on a plurality of samplings of the distributions 535a-535d graph 500c. The first distribution 535a may correspond to the first time bucket 530a, the second distribution 535b may correspond to the second time bucket 530b, and the fourth distribution 535d may correspond to the fourth time bucket 530d. The third distribution 535c may be omitted from the graph 500d, indicating that the third distribution 535c was not sampled. In some implementations, the distributions 535a-d may be iteratively sampled for each individual notification sent to the cluster. For example, to determine a time to send the notification, a random point of each distribution 535a-d may be sampled, and the distribution with the random point corresponding to the largest activity metric can be chosen for sending a notification.

The graph 500d shows the notification deployment trend of graph 500c. Graph 500d shows the most notifications being deployed in the second time bucket 530b, followed by the first time bucket 530a, followed by the fourth time bucket 530d. The deployment trend of graph 500d is shown to align with the average values of the distributions 535a-d. For example, the average value of the second distribution 535b is greatest, and the most notifications are deployed during the second time bucket 530b. As another example, the average value of the fourth distribution 535d is the smallest, and no notifications are shown to be delivered during the fourth time bucket 530d.

Referring to FIGS. 5B and 5D, the posterior distributions and/or reinforcement learning may cause the notification deployment trends to shift. For example, graph 500b shows the most notifications being deployed during the first time bucket 530a, and graph 500d shows the most notifications being deployed during the second time bucket 530b. This may indicate that the user device 145 was interacting with notifications during the first time bucket 530a less frequently than expected (e.g., based on the cluster). As more data is collected for the user device 145, these deployment trends may shift (e.g., adjust, change) further to better align with interaction behavior of the user device 145.

The arrangement, construction, and description of the systems and methods as shown in the various exemplary examples are illustrative only. While some examples have been described herein, several modifications and/or adjustments are possible (e.g., variations in sizes, dimensions, structures, shapes, and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative examples. Other substitutions, modifications, changes, and omissions can be made in the design, operating conditions, and arrangement of the exemplary examples without departing from the scope of the present disclosure.

The present disclosure contemplates methods, systems, and program products on any machine-readable media for accomplishing various operations. The examples of the present disclosure can be implemented using existing computer processors, or by a special purpose computer processor for an appropriate system, incorporated for this or another purpose, or by a hardwired system. Examples within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium, which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data, which cause a general-purpose computer, special purpose computer, or special purpose processing machines to perform a certain function or group of functions.

As used herein, an element or step recited in the singular and proceeded with the word “a” or “an” should be understood as not excluding plural elements or steps, unless such exclusion is explicitly recited. Furthermore, references to “exemplary example,” “one example,” or “some example” of the present disclosure are not intended to be interpreted as excluding the existence of additional examples that also incorporate the recited features.

It should be noted that the term “exemplary” and variations thereof, as used herein to describe various examples, are intended to indicate that such examples are possible examples, representations, or illustrations of possible examples (and such terms are not intended to connote that such examples are necessarily extraordinary or superlative examples).

The patent claims at the end of this document are not intended to be construed as including means-plus function limitations (e.g., under 35 U.S.C. § 112(f)), unless traditional means-plus-function language is expressly recited, such as “means for” or “step for” language being expressly recited in the claim(s).

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples, or that one or more examples necessarily include logic for deciding, with or without other input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art may recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, or “at least one of A, B, or C” is used, in both cases such usage should be interpreted as covering any permutation of A, B, or C, alone or in combination, unless expressly indicated otherwise (e.g., “a system having at least one of A, B, and C” would include systems that have A alone, B alone, C alone, A and B together, A and C together, B and C together, and A, B, and C together). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.” Further, unless otherwise noted, the use of the words “approximate,” “about,” “around,” “substantially,” etc., mean plus or minus ten percent.

The term “coupled” and variations thereof, as used herein, means the joining of two members, directly or indirectly, to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A notification system for determining timing of transmitting notifications to a user, the system comprising:
a non-transitory computer-readable medium having instructions stored thereon that, when executed by one or more processors, cause the one or more processors to:
assign the user to a cluster of a plurality of clusters of users based on one or more characteristics of the user and the clusters of users;
generate a baseline probability distribution for the cluster across a plurality of time buckets, the baseline probability distribution comprising a distribution of probabilities of users of the cluster interacting with a notification transmitted during the plurality of time buckets, the plurality of time buckets covering different time ranges;
transmit, to the user, a first plurality of notifications during a first set of two or more of the plurality of time buckets, wherein an amount of notifications sent within each time bucket of the first set of two or more of the plurality of time buckets is determined using the baseline probability distribution for the cluster;
obtain behavior data indicating whether the user interacted with the first plurality of notifications;
adjust the baseline probability distribution based on the behavior data to generate a personalized probability distribution for the user; and
transmit a second plurality of notifications during a second set of two or more of the plurality of time buckets using the personalized probability distribution for the user.

2. The notification system of claim 1, wherein the instructions cause the one or more processors to:
obtain behavior data indicating whether the user interacted with the second plurality of notifications during the second set of two or more of the plurality of time buckets; and
adjust the personalized probability distribution based on the behavior data.

3. The notification system of claim 2, wherein the instructions cause the one or more processors to adjust the personalized probability distribution by inputting the behavior data into a reinforcement learning model.

4. The notification system of claim 1, wherein the first set of two or more of the plurality of time buckets (a) comprises at least one of a same time bucket as the second set of two or more of the plurality of time buckets or (b) comprises none of the same time buckets as the second set of two or more of the plurality of time buckets.

5. The notification system of claim 1, wherein the baseline probability distribution is a Bayesian probability distribution, and where the instructions cause the one or more processors to generate the baseline probability distribution using a Bayesian model.

6. The notification system of claim 1, wherein the amount of notifications sent during the first set of two or more of the plurality of time buckets of is based on a likelihood of interaction for the users of the cluster.

7. The notification system of claim 1, where an interaction with a notification comprises at least one of (a) an application visit, (b) a webpage visit, (c) a purchase, or (d) an interaction with an embedded link of the notification.

8. The notification system of claim 1, wherein adjusting the baseline probability distribution to generate the personalized probability distribution comprises:
determining, based on the behavior data, a first set of probabilities of the user to interact with a notification sent during each time bucket of the first set of two or more of the plurality of time buckets;
comparing the first set of probabilities to a second set of probabilities indicated by the baseline probability distribution; and
adjusting the baseline probability distribution such that the personalized probability distribution indicates the first set of probabilities.

9. The notification system of claim 8, wherein the first set of probabilities and the second set of probabilities are different for at least one of the first set of two or more of the plurality of time buckets.

10. A method, comprising:
assigning a user to a cluster of a plurality of clusters of users based on one or more characteristics of the user and the clusters of users;
generating a baseline probability distribution for the cluster across a plurality of time buckets, the baseline probability distribution comprising a distribution of probabilities of users of the cluster interacting with a notification transmitted during the plurality of time buckets, the plurality of time buckets covering different time ranges;
obtaining behavior data indicating whether the user interacted with a first plurality of notifications during a first set of two or more of the plurality of time buckets, wherein an amount of notifications sent within each time bucket of the first set of two or more of the plurality of time buckets is determined using the baseline probability distribution for the cluster; and
adjusting the baseline probability distribution based on the behavior data to generate a personalized probability distribution for the user.

11. The method of claim 10, further comprising:
obtaining behavior data indicating whether the user interacted with a second plurality of notifications transmitted during a second set of two or more of the plurality of time buckets using the personalized probability distribution; and
adjusting the personalized probability distribution based on the behavior data.

12. The method of claim 11, further comprising:
adjusting the personalized probability distribution by inputting the behavior data into a reinforcement learning model.

13. The method of claim 11, wherein the first set of two or more of the plurality of time buckets (a) comprises at least one of a same time bucket as the second set of two or more of the plurality of time buckets or (b) comprises none of the same time buckets as the second set of two or more of the plurality of time buckets.

14. The method of claim 10, wherein the baseline probability distribution is a Bayesian probability distribution, the method further comprising:
generating the baseline probability distribution using a Bayesian model.

15. The method of claim 10, further comprising:
determining, based on the behavior data, a first set of probabilities of the user to interact with a notification sent during each time bucket of the first set of two or more of the plurality of time buckets;
comparing the first set of probabilities to a second set of probabilities indicated by the baseline probability distribution; and
adjusting the baseline probability distribution such that the personalized probability distribution indicates the first set of probabilities.

16. One or more non-transitory computer-readable media storing instructions thereon that, when executed by one or more processors, cause the one or more processors to:
assign a user to a cluster of a plurality of clusters of users based on one or more characteristics of the user and the clusters of users;
generate a baseline probability distribution for the cluster across a plurality of time buckets, the baseline probability distribution comprising a distribution of probabilities of users of the cluster interacting with a notification transmitted during the plurality of time buckets, the plurality of time buckets covering different time ranges;
obtain behavior data indicating whether the user interacted with a first plurality of notifications during a first set of two or more of the plurality of time buckets, wherein an amount of notifications sent within each time bucket of the first set of two or more of the plurality of time buckets is determined using the baseline probability distribution for the cluster; and
adjust the baseline probability distribution based on the behavior data to generate a personalized probability distribution for the user.

17. The one or more non-transitory computer-readable media of claim 16, wherein the instructions further cause the one or more processors to:
obtain behavior data indicating whether the user interacted with a second plurality of notifications transmitted during a second set of two or more of the plurality of time buckets using the personalized probability distribution; and
adjust the personalized probability distribution based on the behavior data.

18. The one or more non-transitory computer-readable media of claim 17, wherein the instructions further cause the one or more processors to:
adjust the personalized probability distribution by inputting the behavior data into a reinforcement learning model.

19. The one or more non-transitory computer-readable media of claim 17, wherein the first set of two or more of the plurality of time buckets (a) comprises at least one of a same time bucket as the second set of two or more of the plurality of time buckets or (b) comprises none of the same time buckets as the second set of two or more of the plurality of time buckets.

20. The one or more non-transitory computer-readable media of claim 16, wherein the baseline probability distribution is a Bayesian probability distribution, and wherein the instructions further cause the one or more processors to:
generate the baseline probability distribution using a Bayesian model.
